(19) United States
(12) Patent Application Publication
(10) Pub. No.: US 2026/0046619 A1
(43) Pub. Date: Feb. 12, 2026

(54) METHOD AND APPARATUS FOR MANAGING USER CONSENT FOR NESTED API INVOCATION IN A WIRELESS COMMUNICATION SYSTEM

(71) Applicant: Samsung Electronics Co., Ltd., Suwon-si (KR)

(72) Inventors: Narendranath Durga TANGUDU, Bangalore (IN); Rajendran ROHINI, Bangalore (IN); Basavaraj Jayawant PATTAN, Bangalore (IN)

(21) Appl. No.: 19/295,095

(22) Filed: Aug. 8, 2025

(30) Foreign Application Priority Data
Aug. 10, 2024 (IN) 202441060591
Jul. 25, 2025 (IN) 2024 41060591

(51) Int. Cl. H04W 12/06; H04W 48/08; H04W 48/16

(52) U.S. Cl. CPC H04W 12/06; H04W 48/08; H04W 48/16

(57) ABSTRACT

The present disclosure relates to a 5G communication system or a 6G communication system for supporting higher data rates beyond a 4G communication system such as long term evolution (LTE). A method performed by a first application programming interface (API) exposing function (AEF) in a wireless communication system is provided. The method includes identifying authorization information based on a first service API invocation request; sending, to a common API framework core function (CCF), a request message to get new authorization information, the request message including the authorization information; receiving, from the CCF, a response message including the new authorization information generated by the CCF in case that the first AEF is allowed for accessing a requested service API for a second AEF; and sending, to the second AEF, a second service API invocation request including the new authorization information.

### CROSS-REFERENCE TO RELATED APPLICATION(S)

This application is based on and claims priority under 35 U.S.C. § 119 (a) of an Indian Provisional patent application No. 20/244,1060591, filed on Aug. 10, 2024, in the Indian Patent Office, and of an Indian Non-Provisional patent application Ser. No. 20/244,1060591, filed on Jul. 25, 2025, in the Indian Patent Office, the disclosure of each of which is incorporated by reference herein in its entirety.

### BACKGROUND

### 1. Field

The disclosure relates to a wireless communication network. More particularly, the disclosure relates to methods for managing user consent in common Application Programming Interface (API) frameworks for supporting nested API invocation in the wireless communication network (or wireless network).

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The Third Generation Partnership Project (3GPP) has agreed to study, as part of the Release 19, enhancements to Common Application Programming Interface (API) Framework (CAPIF) to address various Resource Owner-aware Northbound API access (RNAA) requirements. The RNAA is an API invocation scenario where the API invoker requires authorization from a resource owner. As outlined in clause 5.1.2 of 3GPP technical report (TR) 23.700-22, one of the study's objectives is to manage resource owner consent through interactions between the resource owner and the authorization function in the CAPIF Core Function (CCF) (or CCF entity). In nested API invocation scenario, when the API invoker calls a service API on an API Exposing Function (AEF) (or AEF entity), then in order to fulfil the API invoker's request, the AEF may further invoke other service APIs on other AEFs. This results in a chain of nested service API invocations across different AEFs. To support the current behavior, the API invocation towards a first API exposing function may trigger the subsequent API invocation towards another AEF.

For example, if the API invoker calls the Service Enabler Architecture Layer (SEAL) SS_LocationInfoRetrieval API (clause 9.4.4 of 3GPP TS 23.434), a location management server (acting as the AEF for the API invoker and as an API invoker for the NEF) may invoke Network Exposure Function (NEF) API (Nnef_MonitoringEvent API, as specified in 3GPP TS 29.522) to retrieve a Vertical Application Layer (VAL) of a User Equipment (UE) location information from the Fifth-Generation Core Network (5GC). In nested API scenarios, the nested AEFs may be from same or different API providers or API provider domains.

Clause 8.32 of 3GPP TS 23.222 specifies the mechanism for reducing authorization information inquiry in the nested API invocation case, with the pre-condition that the AEFs in nested chain belong to the same API provider domain. This method in clause 18.32 of TS 23.222, reduces the need for repeated authorization inquiries during the nested API invocation.

Currently, 3GPP TS 23.222, clause 8.32, specifies mechanism for reducing authorization information inquiry in the nested API invocation scenario. The API invoker obtains authorization from the CCF, and invokes the service API exposed by a first API Exposing Function (AEF) entity using the authorization information. To fulfil the request of API invoker, if the first AEF entity decides to invoke service API exposed by a second AEF entity, then the first AEF entity obtains authorization information from CCF for service API access on second AEF entity, and uses that authorization information to invoke the required service API on the second AEF entity.

In the existing approach, as noted in clause 8.32.2 of TS 23.222, the resource owner consent is obtained when the API invoker requests authorization information from the CCF to invoke service API(s) that involve the resource owner's information. For example, API invoker requiring to invoke SS_LocationInfoRetrieval API to fetch resource owner (VAL UE/VAL user) location information. The procedure for obtaining the authorization is specified in TS 33.122. However, in step 4 of clause 8.32.2, of TS 23.222, when first AEF entity requests authorization information from the CCF to invoke a service API exposed by second AEF entity, no resource owner consent is taken. For example, in response to a SS_LocationInfoRetrieval API call from a VAL server, the SEAL Location Management Server may need to invoke the NEF's Nnef_MonitoringEvent API. Even in such scenario, during downstream service API invocations that are related to the resource owner information, the consent of resource owner consent is not obtained. Therefore, the omission of resource owner consent is a security flaw and creates the risk of misuse of resource owner information by malicious AEFs in nested API scenario.

Further, the existing solution in TS 23.222, assumes that first AEF entity and second AEF entity are within the same API provider domain. In real-world scenarios, however, the first AEF entity and second AEF entity may belong to different API provider domains, the user consent in such cases is still applicable. For instance, the SEAL server and NEF can be from different third-party application provider and mobile network operator (MNO). Even in such case, resource owner consent in nested API scenarios where AEFs in the nested API chain are from different API provider domains, is missing and not specified.

Additionally, the current 3GPP mechanisms do not handle the scenarios where authorization information with resource owner consent be obtained for direct service API invocations on the AEF.

The above-mentioned shortcomings result in security vulnerabilities, restricted usage and subject to misuse of resource owner's information by malicious AEFs in nested API case.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for managing user consent in common application programming interface (API) frameworks for wireless communication networks.

Another aspect of the disclosure is to manage the user consent when accessing nested APIs via northbound interfaces using a Common API Framework (CAPIF).

Another aspect of the disclosure is to obtain authorization information with resource owner consent prior to initiating a nested API invocation in the CAPIF.

Another aspect of the disclosure is to ensure that the first API exposing function (AEF) entity acquires the necessary delegated authorization information from the CAPIF Core Function (CCF) before invoking service API on another AEF.

Another aspect of the disclosure is to ensure that the CCF (or CCF entity) to issue delegated access tokens or delegated authorization, to first AEF entity, based on the authorization information of the token received from the API invoker, to maintain the involvement of the resource owner consent.

Additional aspects will be set forth in part in the description which follows and, in part, will be apparent from the description, or may be learned by practice of the presented embodiments.

In accordance with an aspect of the disclosure, a method performed by a first AEF in a wireless communication system is provided. The method includes identifying authorization information based on a first service API invocation request, sending, to a CCF, a request message to get new authorization information, the request message including the authorization information, receiving, from the CCF, a response message including the new information generated by the CCF in case that the first AEF is allowed for accessing a requested service API for a second AEF, and sending, to the second AEF entity, a second service API invocation request including the new authorization information.

In accordance with another aspect of the disclosure, a method performed by a CCF in a wireless communication system is provided. The method includes receiving, from a first AEF, a request message to get new authorization information, the request message including authorization information identified based on a first service API invocation request, validating that the first AEF is allowed for accessing a requested service API for a second AEF, is allowed for accessing a requested service API for a second AEF, and sending, to the first AEF, a response message including the new authorization information.

In accordance with another aspect of the disclosure, a method for managing user consent for at least one nested API invocation in a wireless network by a second AEF entity is provided. The method includes receiving at least one service API invocation request with an authorization information from a first AEF entity. The method includes sending at least one service API invocation response to the first AEF entity based on the at least one service API invocation request, when the second AEF entity validates a service API request and a delegated authorization information in the request message from the first AEF entity.

In accordance with another aspect of the disclosure, a first AEF in a wireless communication system is provided. The first AEF includes at least one transceiver, at least one processor communicatively coupled to the at least one transceiver, and at least one memory, communicatively coupled to the at least one processor, storing instructions executable by the at least one processor individually or in any combination to cause the first AEF to identify authorization information based on a first service API invocation request, send, to a common API framework core function (CCF), a request message to get new authorization information, the request message including the authorization information, receive, from the CCF, a response message including the new authorization information generated by the CCF in case that the first AEF is allowed for accessing a requested service API for a second AEF, and send, to the second AEF, a second service API invocation request including the new authorization information.

In accordance with another aspect of the disclosure, a CCF in a wireless communication system is provided. The CCF includes at least one transceiver, at least one processor communicatively coupled to the at least one transceiver, and at least one memory, communicatively coupled to the at least one processor, storing instructions executable by the at least one processor individually or in any combination to cause the CCF to receive, from a first API exposing function (AEF), a request message to get new authorization information, the request message including authorization information identified based on a first service API invocation request, validate that the first AEF is allowed for accessing a requested service API for a second AEF, generate the new authorization information, and send, to the first AEF, a response message including the new authorization information.

In accordance with another aspect of the disclosure, a second AEF entity is provided. The second AEF includes a processor, a memory, and a user consent managing controller, coupled with the processor and the memory. The user consent managing controller of the second AEF entity is configured to receive at least one service API invocation request with an authorization information from a first AEF entity. The user consent managing controller of the second AEF entity is configured to send at least one service API invocation response to the second AEF entity based on the at least one service API invocation request, when the second AEF entity validates a service API request and a delegated authorization information in the request message from the first AEF entity.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 depicts a procedure to obtain authorization information with resource owner consent prior to nested API invocation, in which an API exposing function receiving a service API invocation request interacts with another API exposing function to provide the service in a wireless network, according to an embodiment of the disclosure;

FIG. 2 depicts the procedure to obtain authorization information with resource owner consent upon the nested API invocation, in which an API exposing function receiving the service API invocation request requires to interact with another API exposing function to provide the service in the wireless network, according to an embodiment of the disclosure;

FIG. 3 illustrates the steps for obtaining authorization information with resource owner consent upon service API invocation in the wireless network, according to an embodiment of the disclosure;

FIG. 4 depicts the procedure to obtain delegated authorization information prior to nested API invocation, in which an API exposing function receiving the service API invocation request requires to interact with another API exposing function to provide the service in the wireless network, according to an embodiment of the disclosure;

FIG. 5 is an example flow diagram illustrating the authorization of API invocation triggered towards a second AEF entity using a token exchange procedure, according to an embodiment of the disclosure;

FIG. 6A is an example diagram illustrating hardware components of the CCF to obtain authorization information with resource owner consent upon the nested API invocation, according to an embodiment of the disclosure;

FIG. 6B is an example diagram illustrating hardware components of the first AEF entity to obtain authorization information with resource owner consent upon the nested API invocation, according to an embodiment of the disclosure;

FIG. 6C is an example diagram illustrating hardware components of the second AEF entity, to obtain authorization information with resource owner consent upon the nested API invocation, according to an embodiment of the disclosure;

FIG. 7 is an example flow diagram depicting a method for managing user consent for the at least one nested API invocation in a wireless network, by the first AEF entity, according to an embodiment of the disclosure;

FIG. 8 is an example flow diagram depicting a method for managing user consent for the at least one nested API invocation in the wireless network, by the CCF entity, according to an embodiment of the disclosure; and

FIG. 9 is an example flow diagram depicting a method for managing user consent for the at least one nested API invocation in the wireless network, by the second AEF entity, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the various embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the various embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

As referred to herein, the term “resource owner” refer to the user/subscriber/UE/VAL UE/VAL User etc., as per definitions in TS 23.222. The resource owner is an entity (either a UE user or an MNO subscriber) capable of granting access to a protected resource related to the invoked API. The resource owner may be the user of the UE or the owner of the subscription depending on the use case and regulations. The resource owner identifier (ID) is specified as a Generic Public Subscription Identifier (GPSI) of the corresponding UE if the resource is related to the UE.

The usage of terms “first API Exposing Function (AEF) entity”, “first AEF entity”, “AEF-1”, “first API exposing function”, “API exposing function 1”, mean the same, and are used interchangeably throughout the document.

The usage of terms “second API Exposing Function (AEF) entity” “second AEF entity”, “AEF-2”, “second API exposing function”, “API exposing function 2”, mean the same and are used interchangeably throughout the document.

The usage of the terms “Common API Framework (CAPIF) Core Function (CCF) entity”, “CCF”, “Authorization function”, mean the same and are used interchangeably throughout the document.

The usage of terms “Northbound API” and “Service API” mean the same, and are used interchangeably throughout the document.

Embodiments herein disclose methods and systems for managing user consent in common API frameworks for supporting nested API invocation in the wireless communication networks. Embodiments herein disclose methods and systems for obtaining authorization information with resource owner consent prior to invoking downstream or nested service API.

Embodiments herein disclose methods and systems for obtaining the authorization information with resource owner consent upon the invocation of downstream or nested service API. The API exposing function invokes the service API directly to downstream API exposing functions. The downstream API exposing functions respond with the indication requiring consent and authorization information. Based on indication from downstream API exposing functions the API exposing function obtains the required authorization information with resource owner consent.

Embodiments herein disclose methods and systems for issuing delegated authorization to API exposing function based on the authorization information from the API invoker.

The resource owner's consent is obtained or taken into consideration by the CCF106, to authorize the invocation of all the service APIs in the nested API scenario. The resource owner's consent to authorize the AEF's during downstream service API invocations (Obtaining prior to nested service API invocation), the procedure for obtaining authorization information in a nested API invocation, as specified in clause 8.32 of 3GPP TS 23.222 is updated with the resource owner involvement to get the authorization information for the first AEF entity to invoke the service API on the second AEF entity.

In an embodiment, the method can be used for obtaining authorization information with resource owner consent prior to the invocation of downstream or nested service API. In an embodiment, the first API exposing function (first AEF) invokes the service API to downstream the second API exposing functions (i.e., second AEF). The first AEF prior to service API invocation obtains the required authorization information with resource owner consent from the CCF. In an embodiment, the method can be used for the CCF issuing delegated authorization (e.g., delegated access token) to the first AEF based on the authorization information from the API invoker. Hence, the proposed method resolves the issue of managing the user consent in nested API service invocation scenario in an optimized and efficient manner without wasting a resource (e.g., signaling resource, or the like).

The proposed method can be used to enable the resource owner consent applicability during nested API invocations. With complex network deployments, the nested API calls are frequent and common. In such scenarios, the proposed method can be used for minimizing the user involvement (for instance, capturing the consent multiple times) for a given API invocation. This results in enhancing the user experience and security posture of the API invocation.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

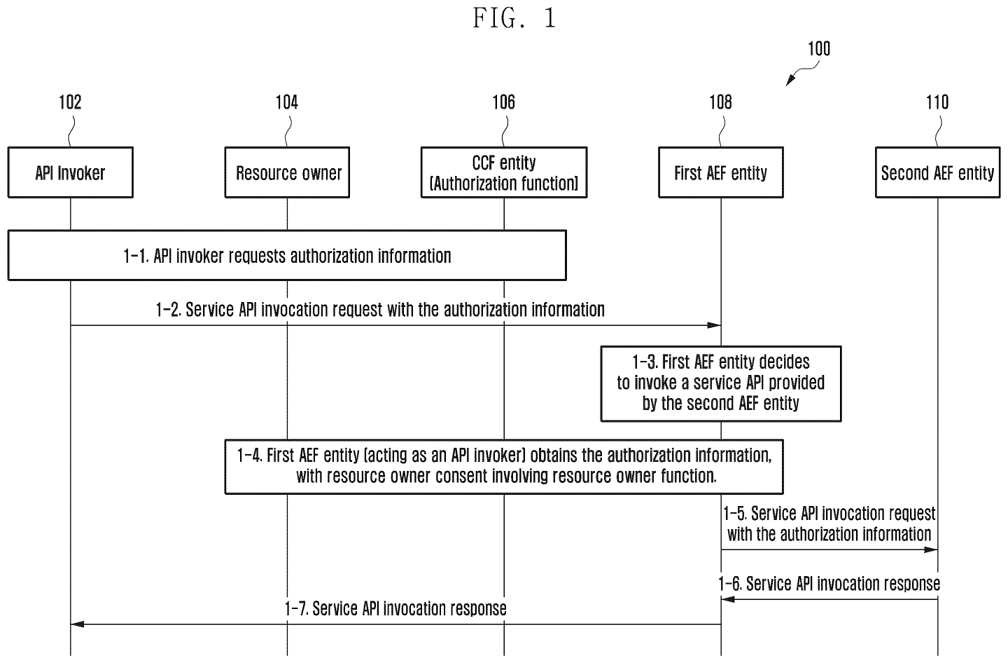

Referring now to the drawings, and more particularly to FIGS. 1 to 5, 6A to 6C, and 7 to 9, where similar reference characters denote corresponding features consistently throughout the figures, there are shown embodiments.

FIG. 1 is an example flow diagram illustrating to obtain authorization information with resource owner consent prior to nested API invocation, in which an API exposing function receiving the service API invocation request interacts with another API exposing function to provide a service in a wireless network 100 according to an embodiment of the disclosure.

Referring to FIG. 1, in step 1-1, the API invoker 102 obtains the authorization information to invoke the service API on the first AEF entity 108, with involvement of resource owner function in issuing resource owner consent to the API invoker 102. In an embodiment, the procedures specified in clause 8.31 of 3GPP TS 23.222 may be used here, to obtain the authorization information with involvement of resource owner function 104. In step 1-2, the API invoker 102 invokes the service API in the first AEF entity 108 using the authorization information. In step 1-3, to fulfil the API invoker's request, the first AEF entity 108 decides to invoke service API in the second AEF entity 110. To do so, in step 1-4, the first AEF entity 108, obtains the authorization information to invoke the service API on the second AEF entity 110, with the involvement of resource owner 104 in issuing resource owner consent to the first AEF entity 108. The procedures specified in clause 8.31 of 3GPP TS 23.222 is used in this step, to obtain the authorization information with involvement of resource owner 104. The resource owner 104 is involved in obtaining the resource owner consent to issue the authorization to first AEF entity 108 to invoke service API on the second AEF entity 110. Even though the API invoker 102 has obtained authorization information with the resource owner consent, the first AEF entity 108 still needs to obtain authorization with resource owner consent for invoking the service API on the second AEF entity 110. This procedure of step 1-4, further applies to any other further downstream service API invocations where resource owner consent is needed. Thus, ensuring all the service API invocations in nested API scenario are done with resource owner's consent.

In step 1-5, the first AEF entity 108 invokes the required service API on the second AEF entity 110 using the authorization information with resource owner consent obtained in the previous step (i.e., step 1-4). In step 1-6, after successful validation of the first API exposing function 108 authorization information and the service API request by the second AEF entity 110, the first AEF entity 108 receives the service API response from the second AEF entity 110. In step 1-7, the first AEF entity 108 responds to the API invoker 102, with appropriate Service API response message.

In another embodiment, where the resource owner's consent to authorize the AEF's during downstream service API invocations (obtaining upon the nested service API invocation). The procedure is used for obtaining authorization information with resource owner consent upon nested API invocation, where the API exposing function to invoke the downstream service APIs, and obtains authorization upon the downstream service API invocation. Thus, providing alternative to procedure as specified in clause 8.32 of 3GPP TS 23.222, wherein the first AEF entity 108, obtains the authorization information including resource owner consent, upon the service API invocation on the second AEF entity 110.

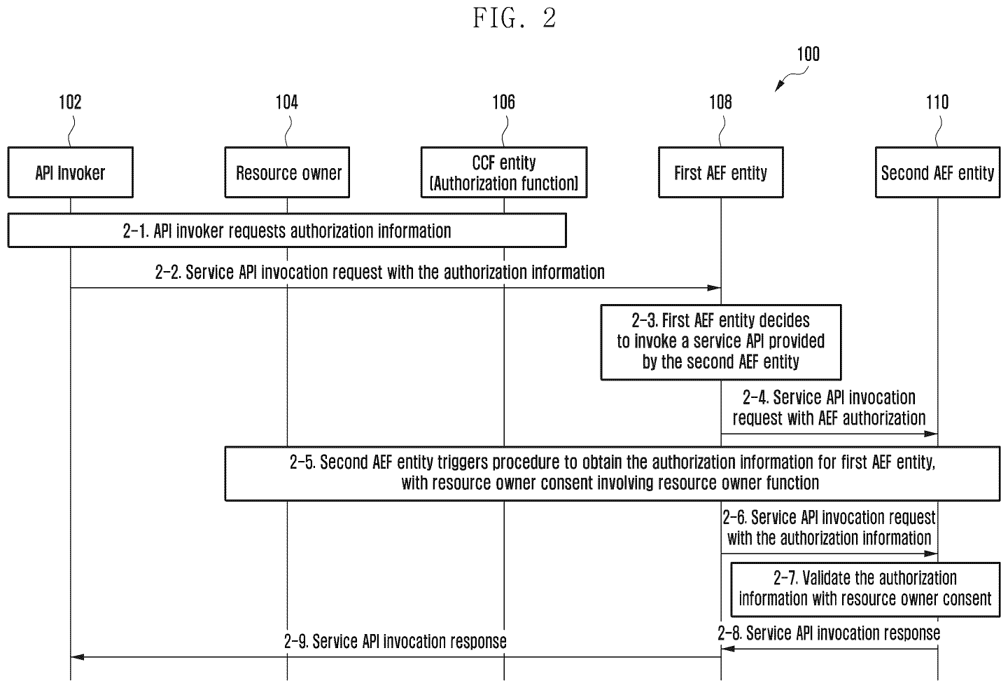

FIG. 2 is an example flow diagram illustrating to obtain authorization information with the resource owner consent upon the nested API invocation, in which an API exposing function receiving the service API invocation request requires to interact with another API exposing function to provide the service according to an embodiment of the disclosure.

Referring to FIG. 2, in step 2-1, the API invoker 102 obtains the authorization information to invoke the service API on the first AEF entity 108, with involvement of resource owner function 104 in issuing the resource owner consent to the API invoker 102.

In an embodiment, the procedures specified in clause 8.31 of 3GPP TS 23.222 may be used, to obtain the authorization information with involvement of the resource owner function 104. In step 2-2, the API invoker 102 invokes the service API in the first AEF entity 108 using the authorization information in step 2-1. To fulfil the API invoker's request, in step 2-3, the first AEF entity 108 decides to invoke service API in second AEF entity 110. In step 2-4, the first AEF entity 108 invokes with required service API directly on the second AEF entity 110 without the authorization information, as specified in clause 8.16, 3GPP TS 23.222.

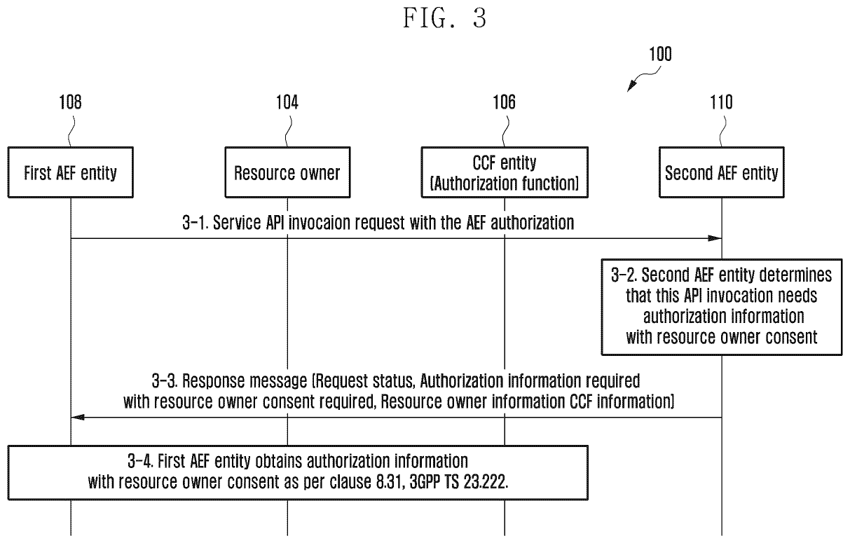

In step 2-5, the second AEF entity 110 triggers a procedure (as depicted in FIG. 3, which depicts the procedure for obtaining authorization information upon service API invocation) to obtain the authorization information for first AEF entity 108 with resource owner consent involving resource owner function 104 and the CCF entity 106. In step 2-5, the first AEF entity 108 obtains the required authorization information with resource owner consent.

In step 2-6, the first AEF entity 108 invokes the service API on the second AEF entity 110 with the authorization information with resource owner consent, as specified in clause 8.31, 3GPP TS 23.222. In step 2-7, the second AEF entity 110, validates the service API request and the authorization information with resource owner consent. If it is valid and matching the context of the service API request, then the second AEF entity 110, executes the service API request. In step 2-8, the second AEF entity 110 responds to first AEF entity 108 with the appropriate Service API response message. In step 2-9, based on the service API response message from API exposing function 2, the first AEF entity 108 responds to the API invoker 102 with appropriate service API response message.

FIG. 3 is an example flow diagram illustrating to obtain authorization information with resource owner consent upon service API invocation according to an embodiment of the disclosure.

Referring to FIG. 3, in step 3-1, the first AEF entity 108 invokes with service API directly on the second AEF entity 110 without the authorization information, as specified in clause 8.16, 3GPP TS 23.222.

In step 3-2, the second AEF entity 110, determines that the required authorization information with resource owner consent is not available to authorize the service API request from first AEF entity 108. In step 3-3, the second AEF entity 110 responds to the first AEF entity 108, with response message indicating the failure status of the request message, and indicates the reason of failure that the authorization information with resource owner consent is not available for the resource owner(s) in the service API request. The information included in the response message is shown in Table 1.

TABLE 1

| Information | | |
|---|---|---|
| element | Status | Description |
| Request status | M | Indicates that the request message has |
| | (Mandatory) | failed. |
| Authorization | M | Indicates that the required authorization |
| information with | | information with resource owner |
| resource owner | | consent is required. |
| consent required | | |
| Resource Owner | M | Identifiers or other information related |
| (s) | | to the resource owners for which the |
| | | authorization information with resource |
| | | owner consent is needed. |
| CCF Information | O | Information related to the CCF, which |
| | | can be used for obtaining the |
| | | authorization information with resource |
| | | owner consent. Information could be |
| | | related to reaching the CCF (like URL, |
| | | DNN to reach CCF, IP address of CCF |
| | | and like so), Identifier of the CCF and |
| | | like so. |
| | | If this information is not available, the |
| | | first AEF entity may contact the CCF |
| | | that it is configured with or the CCF |
| | | information that is aware of. |

In step 3-4, based on the information received from second AEF entity 110, the first AEF entity 108 obtains the authorization information with resource owner consent for the required resource owners, using the procedure in clause 8.31 of 3GPP TS 23.222.

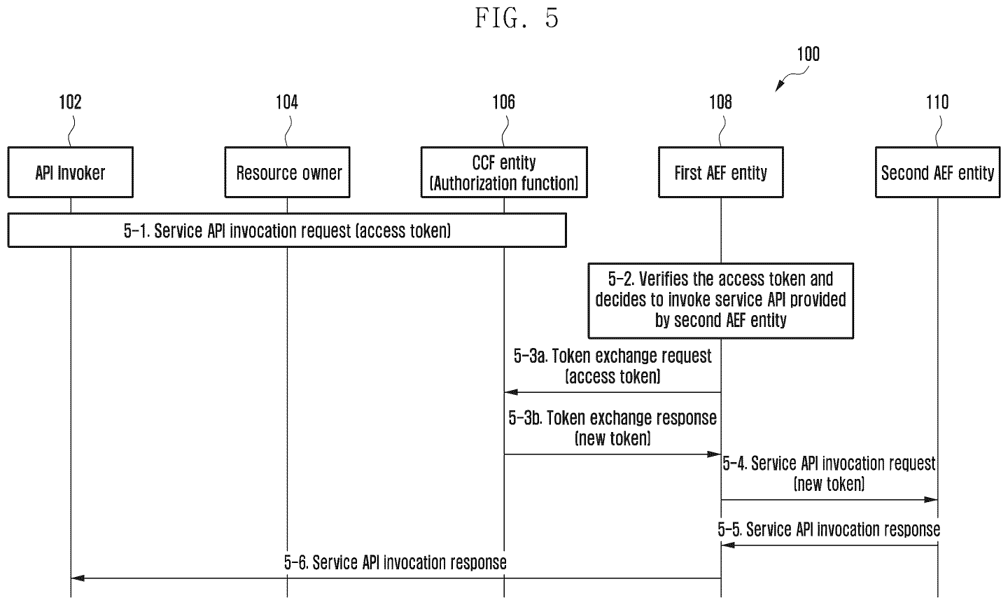

In an embodiment herein, related to FIG. 5, the API exposing function 104 can be an API invoker 102 and the second AEF entity 110 can be a first AEF entity 108. In such a scenario, the API invoker 102 may directly invoke the service API on API exposing function. Hence, can be used to obtain the resource owner consent upon service API invocation from the API invoker 102.

In delegated resource owner's consent to authorize the AEF during downstream service API invocations (obtaining prior to nested service API invocation). The procedure is used for obtaining delegated authorization information in a nested API invocation, as specified in clause 8.32 of 3GPP TS 23.222 is updated to get the authorization information prior to API Exposing Function 1 108 invoking the service API on second AEF entity 110. Hence, FIG. 3 illustrates, for first AEF entity 108 to obtain a delegated authorization information based on the authorization information with resource owner consent from API invoker 102, to invoke the service API on second AEF entity 110.

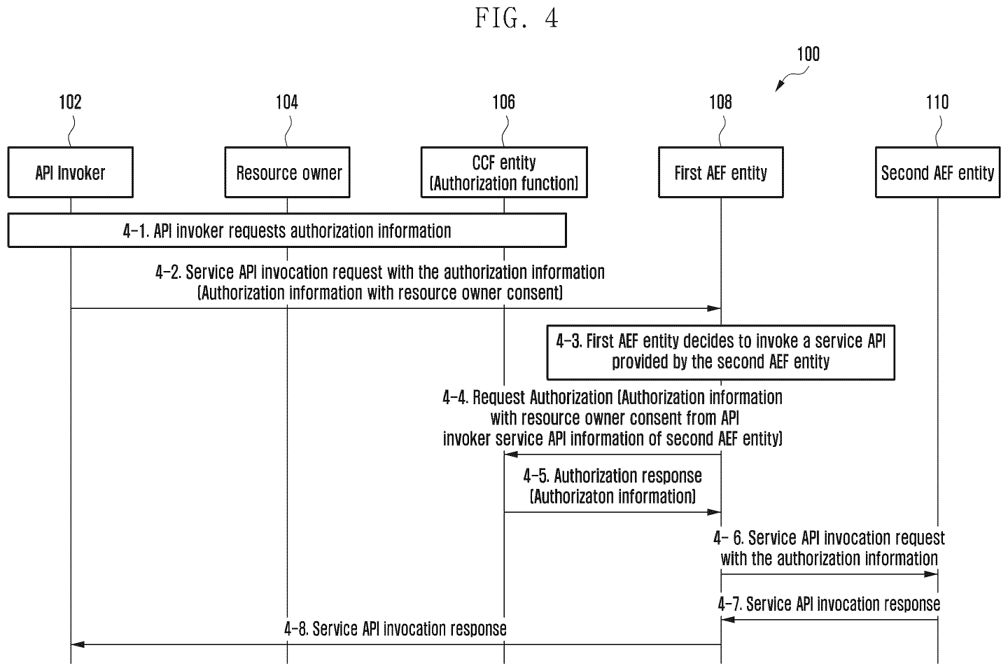

FIG. 4 is an example diagram depicting to obtain delegated authorization information prior to nested API invocation, in which an API exposing function receiving the service API invocation request requires to interact with another API exposing function to provide the service according to an embodiment of the disclosure.

Referring to FIG. 4, in step 4-1, the API invoker 102 obtains the authorization information to invoke the service API on first AEF entity 108, with involvement of the resource owner function 104 in issuing resource owner consent to the API invoker 102. In an embodiment, the procedures specified in clause 8.31 of 3GPP TS 23.222 may be used, to obtain the authorization information with involvement of resource owner function 104 for resource owner consent.

In step 4-2, API invoker 102 invokes the service API in the first AEF entity 108 using the authorization information. In step 4-3, to fulfil the API invoker's request, the first AEF entity 108 decides to invoke service API in second AEF entity 110. Hence, the first AEF entity 108 needs to obtain the authorization information with resource owner consent to invoke the service API on second AEF entity 110. Hence, in step 4-4, the first AEF entity 108 sends request authorization message to the CCF 106, requesting the CCF 106 to issue the authorization information to invoke the service API in second AEF entity 110. The request message includes information as shown in Table 2.

TABLE 2

| Information | | |
|---|---|---|
| element | Status | Description |
| Authorization | M | The authorization information with |
| information | | resource owner consent obtained from |
| | | API invoker in the service API request |
| | | message. |
| Security | M | Security information related to first AEF |
| information | | entity to validate the request from API |
| | | exposing function 1. |
| Resource Owner | M | Identifiers or other information related to |
| (s) Information | | the resource owners for which the |
| | | authorization information with resource |
| | | owner consent is needed. |
| Service API | M | Information related to the service API, |
| access | | service API request parameters and the |
| | | API exposing function 2, for which the |
| | | delegated authorization is requested. |

In step 4-5, the CCF 106 validates the request from first AEF entity 108. The CCF 106 validates whether the requesting first AEF entity 108 is allowed for delegated authorization to access service API related to the resource owners 104 on the second AEF entity 110. Also, the CCF 106 validates the authorization information in the request message that is provided by the API invoker 102 to the first AEF entity 108. After successful validation, the CCF 106 responds to first AEF entity 108 with the authorization response message that includes the delegated authorization information to allow first AEF entity 108 to invoke the service API on the second AEF entity 110. The information in the response message is shown in Table 3.

TABLE 3

| Information | | |
|---|---|---|
| element | Status | Description |
| Delegated | M | The delegated authorization information |
| authorization | | with resource owner consent. |
| information | | |
| > Resource owner | M | Identifiers or other information related to |
| (s) information | | the resource owners for which the |
| | | authorization information is applicable |
| > Authorization | M | The authorization information with |
| information about | | resource owner consent provided by API |
| primary subject | | invoker in the request message. |
| > Delegated subject | M | Information related to entities for which |
| | | the delegated authorization is applicable. |
| | | In this case, the information related to |
| | | API exposing function 1. |
| > Expiry time | M | Time for which the delegated |
| | | authorization is valid. |
| > Allowed | M | Information related to allowed service |
| permissions | | API access and the permissions or |
| | | permitted service operations or permitted |
| | | API resources on the service APIs. |
| > Allowed API | M | The API exposing function (s) where the |
| Exposing Functions | | allowed permissions are applicable. In |
| | | this case, the information related to API |
| | | exposing function 2. |

In step 4-6, the first AEF entity 108 invokes the required service API on second AEF entity 110 using the authorization information obtained in step 4-5. In step 4-7, the second AEF entity 110 validates the service API request and the delegated authorization information in the request message from first AEF entity 108. The second AEF entity 110 validates, if the resource owner information in the service API request message and resource owner information in delegated authorization information is matching. If the delegated subject in delegated authorization information is same as the requesting first AEF entity 108, expiry time to validate the time of the request, validates the authorization information from the actual subject (API invoker) to ensure resource owner consent is available and like so. Upon successful validation, the first AEF entity 108 receives the service API response from second AEF entity 110. In step 4-8, the first AEF entity 108 responds to API invoker 102 with appropriate Service API response message.

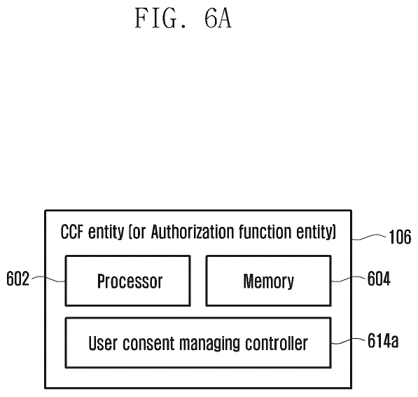

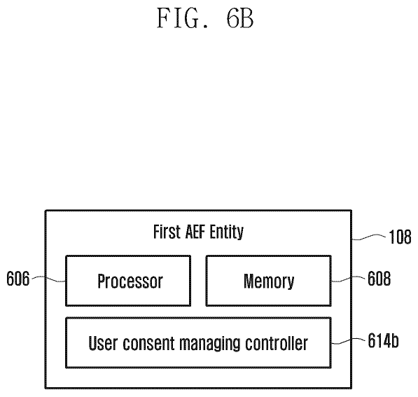

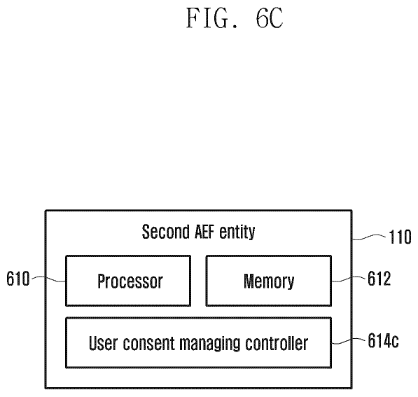

In an embodiment herein, in FIGS. 6A to 6C illustrated above can be also realized with the provisions in OAuth 2.0 token exchange (IETF RFC 8693) mechanisms for managing security tokens employing impersonation and delegation. Mapping the provisions of IETF RFC 8693, the first AEF entity is the actor subject, the API invoker 102 is the primary subject, the CCF 106 is the authorization server. In such a scenario, the requesting entity first AEF entity 108 requests a security token from the CCF 106 by making a token request to the authorization server's token endpoint on CCF106, using the extension grant type mechanism defined in Section 4.5 of IETF RFC6749.

FIG. 5 is an example flow diagram illustrating the authorization of API invocation triggered towards the second API exposing function 110 using token exchange procedure according to an embodiment of the disclosure.

In an embodiment as disclosed herein, in the nested API invocation where an API invocation towards the first AEF entity 108 triggers the API exposing function 108 requests an API invocation towards the second AEF entity 110 i.e., first AEF entity becomes API invoker 102 for the second AEF entity 110. Therefore, both belong to the same API provider domain. In such a scenario, the CCF 106 may reduce the authorization information inquiries for the nested API invocation.

Referring to FIG. 5, the authorization of the API invocation triggered towards the second API exposing function 110 uses token exchange procedure as specified in IETF RFC 8693, where the access token of the API invoker 102 to be used towards first AEF entity 108, which is used as the subject token as per the IETF RFC 8693. The first AEF entity 108 before triggering API invocation towards second AEF entity 110, invokes the token exchange request towards the CCF 106 by sending the subject token to receive a new access token. first AEF entity 108 uses the received new access token towards the second AEF 110 for nested API invocation.

Referring to FIG. 5, in step 5-1, the first API invoker 102 invokes the first AEF entity 108 service by using the access token obtained from the CCF/Authorization Function 106. In step 5-2, based on the service API invocation request, the first AEF entity 108 verifies the access token and decides to invoke another service API exposed by the second AEF 110. Hence, in step 5-3a, the first AEF entity 108 sends a token exchange request message to the CCF 106, to receive a token to invoke the service API in the second AEF (or AEF-2) 110. The token exchange request message contains a grant_type, the access token as the subject_token, optionally an actor_token, and optionally scope for the desired scope of the requested token. The actor_token in the request message indicates the delegated authorization request, wherein the grant-type is set as the token-exchange. In step 5-3b, the CCF 106 validates whether the requesting first AEF entity 108 is allowed for accessing the requested service API of the second AEF110.

Also, the CCF 106 validates the access token in the request message that is provided by the API invoker 102 to first AEF entity 108. After successful validation, the CCF 106 generates a new access token to allow first AEF entity 108 to invoke the service API on the second AEF 110. The CCF 106 checks whether the received token is an RNAA token and if so, issues the new token as an RNAA token which includes the AEF ID in the (act) actor claim optionally, the API invoker ID, the resource owner ID and the scope, in addition to the standard access token claims as specified in 3GPP TS 33.122. The CCF 106 responds to the first AEF entity 108 with the token exchange response message including the newly issued access token and optionally the scope (if required) for service API invocation on the second AEF 110.

Further, in step 5-4, the first AEF entity 108, sends a service API invocation request to the second AEF 110 with the authorization information i.e., access token received in step 5-3b. In step 5-5, the second AEF 110 checks whether the API invoker 102 is authorized to invoke the requested service API based on the received token and if allowed, the second AEF 110 sends a service API invocation response. In step 5-6, the API invoker 102 receives from first AEF entity 108 the service API invocation response after the service API invocation from the second AEF 110.

FIG. 6A shows various hardware components of the CCF entity 106, according to an embodiment of the disclosure.

Referring to FIG. 6A, the CCF entity 106 includes a processor 602, a memory 604, and a user consent managing controller 614a. The processor 602 is coupled with the memory 604, and the user consent managing controller 614a.

The user consent managing controller 614a receives the request authorization message from the first AEF entity 108. The request authorization message includes the authorization information with resource owner consent received from the API invoker and requests the CCF entity 106 to provide the authorization information to invoke the service API provided in the second AEF entity 110. Further, the user consent managing controller 614a performs at least one of: validates the request authorization message received from the first AEF entity 108, validates whether the first AEF entity 108 is allowed for delegated authorization to access the service API related to the resource owner 104 on the second AEF entity 110, or validate the authorization information in the request authorization message that is provided by the API invoker 102 to the first AEF entity 108. Based on the validation, the user consent managing controller 614a sends the authorization response message including the authorization information to the first AEF entity 108.

The user consent managing controller 614a is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 602 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 602 may include multiple cores and is configured to execute the instructions stored in the memory 604.

Further, the processor 602 is configured to execute instructions stored in the memory 604 and to perform various processes. A communicator (not shown) is configured for communicating internally between internal hardware components and with external devices via one or more networks. The memory 604 also stores instructions to be executed by the processor 602. The memory 604 may include non-volatile storage elements. Examples of such non-volatile storage elements may include magnetic hard discs, optical discs, floppy discs, flash memories, or forms of electrically programmable read only memories (EPROMs) or electrically erasable and programmable ROMs (EEPROMs) memories. In addition, the memory 604 may, in some examples, be considered a non-transitory storage medium. The term “non-transitory”may indicate that the storage medium is not embodied in a carrier wave or a propagated signal. However, the term “non-transitory” should not be interpreted that the memory 604 is non-movable. In certain examples, a non-transitory storage medium may store data that can, over time, change (e.g., in Random Access Memory (RAM) or cache).

Although FIG. 6A shows various hardware components of the CCF entity 106 but it is to be understood that other embodiments are not limited thereon. In other embodiments, the CCF entity 106 may include a lessor or greater number of components. Further, the labels or names of the components are used only for illustrative purposes and does not limit the scope of the disclosure. One or more components can be combined together to perform the same or substantially similar function in the CCF entity 106.

FIG. 6B shows various hardware components of the first AEF entity 108, according to an embodiment of the disclosure.

Referring to FIG. 6B, the first AEF entity 108 includes a processor 606, a memory 608, and a user consent managing controller 614b. The processor 606 is coupled with the memory 608, and the user consent managing controller 614b.

The user consent managing controller 614b receives the service API invocation request from the API invoker 102. Further, the user consent managing controller 614b determines to invoke the service API provided by the second AEF entity 110 based on the service API invocation request. Further, the user consent managing controller 614b sends the request authorization message to the CCF entity 106, where the request authorization message includes the authorization information with resource owner consent received from the API invoker and requests the CCF entity 106 to provide the authorization information to invoke the service API provided in the second AEF entity 110.

Further, the user consent managing controller 614b receives the authorization response message including the authorization information from the CCF entity 106 based on the request authorization message. Further, the user consent managing controller 614b sends the service API invocation request with the authorization information to the second AEF entity 110.

Further, the user consent managing controller 614b receives the service API invocation response from the second AEF entity 110 based on the service API invocation request. In an embodiment, the user consent managing controller 614b receives the service API invocation response from the second AEF entity 110 when the second AEF entity 110 validates the service API request and the delegated authorization information in the request message from the first AEF entity 108. In another embodiment, the user consent managing controller 614b receives the service API invocation response from the second AEF entity 110 when the second AEF entity 110 validates if a resource owner information in the service API request message and resource owner information in delegated authorization information are matching, if a delegated subject in delegated authorization information is same as the first AEF entity 108, expiry time to validate the time of the request, validates the authorization information from the API invoker 102.

The user consent managing controller 614b is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 606 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 606 may include multiple cores and is configured to execute the instructions stored in the memory 608.

Further, the processor 606 is configured to execute instructions stored in the memory 608 and to perform various processes. A communicator (not shown) is configured for communicating internally between internal hardware components and with external devices via one or more networks. The memory 608 also stores instructions to be executed by the processor 606. The memory 608 may include non-volatile storage elements. Examples of such non-volatile storage elements may include magnetic hard discs, optical discs, floppy discs, flash memories, or forms of electrically programmable ROMs (EPROMs) or electrically erasable and programmable ROMs (EEPROM). In addition, the memory 608 may, in some examples, be considered a non-transitory storage medium. The term “non-transitory” may indicate that the storage medium is not embodied in a carrier wave or a propagated signal. However, the term “non-transitory” should not be interpreted that the memory 608 is non-movable. In certain examples, a non-transitory storage medium may store data that can, over time, change (e.g., in Random Access Memory (RAM) or cache).

Although FIG. 6B shows various hardware components of the first AEF entity 108 but it is to be understood that other embodiments are not limited thereon. In other embodiments, the first AEF entity 108 may include a lessor or greater number of components. Further, the labels or names of the components are used only for illustrative purposes and does not limit the scope of the disclosure. One or more components can be combined together to perform the same or substantially similar function in the first AEF entity 108.

FIG. 6C shows various hardware components of the second AEF entity 110, according to an embodiment of the disclosure.

Referring to FIG. 6C, the second AEF entity 110 includes a processor 610, a memory 612, and a user consent managing controller 614c. The processor 610 is coupled with the memory 612, and the user consent managing controller 614c.

The user consent managing controller 614c receives the at least one service API invocation request with the authorization information from the first AEF entity 108. Further, the user consent managing controller 614c sends the at least one service API invocation response to the second AEF entity 110 based on the service API invocation request, when the second AEF entity 110 validates the service API request and the delegated authorization information in the request message is related to the resource owner in the service API request from the first AEF entity 108.

The user consent managing controller 614c is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 610 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 610 may include multiple cores and is configured to execute the instructions stored in the memory 612.

Further, the processor 610 is configured to execute instructions stored in the memory 612 and to perform various processes. A communicator (not shown) is configured for communicating internally between internal hardware components and with external devices via one or more networks. The memory 612 also stores instructions to be executed by the processor 610. The memory 612 may include non-volatile storage elements. Examples of such non-volatile storage elements may include magnetic hard discs, optical discs, floppy discs, flash memories, or forms of electrically programmable ROMs (EPROMs) or electrically erasable and programmable ROMs (EEPROM). In addition, the memory 612 may, in some examples, be considered a non-transitory storage medium. The term “non-transitory” may indicate that the storage medium is not embodied in a carrier wave or a propagated signal. However, the term “non-transitory” should not be interpreted that the memory 612 is non-movable. In certain examples, a non-transitory storage medium may store data that can, over time, change (e.g., in Random Access Memory (RAM) or cache).

Although FIG. 6C shows various hardware components of the second AEF entity 110 but it is to be understood that other embodiments are not limited thereon. In other embodiments, the second AEF entity 110 may include a lessor or greater number of components. Further, the labels or names of the components are used only for illustrative purposes and does not limit the scope of the disclosure. One or more components can be combined together to perform the same or substantially similar function in the second AEF entity 110.

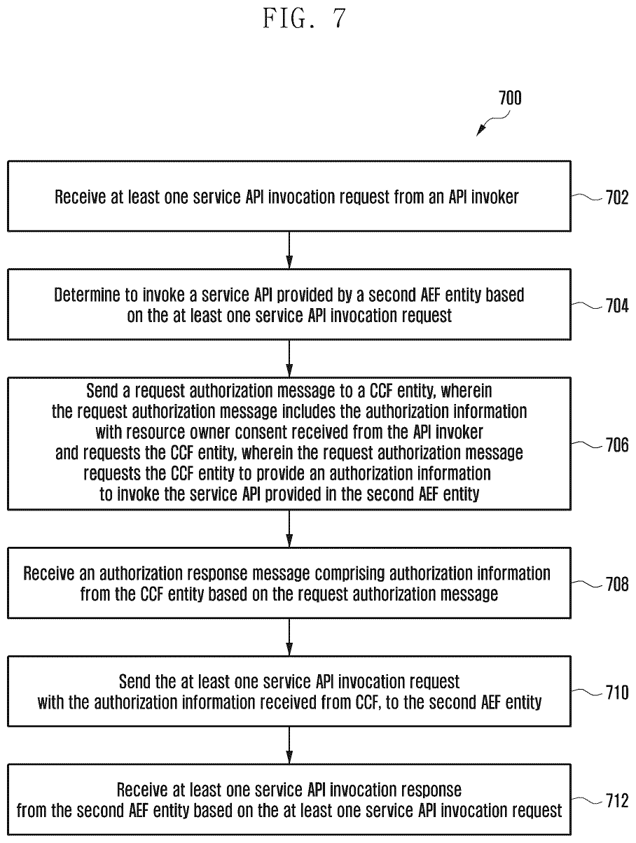

FIG. 7 is an example flow diagram 700 depicting a method for managing user consent for at least one nested API invocation in the wireless network 100, by the first AEF entity 108 according to an embodiment of the disclosure.

Referring to FIG. 7, in operation 702, the first AEF entity 108 may determine the at least one service API invocation request from the API invoker 102. In operation 704, the first AEF entity 108 may determine to invoke the service API provided by the second AEF entity 110 based on the at least one service API invocation request. In operation 706, the first AEF entity 108 may send the request authorization message to the CCF entity 106, where the request authorization message includes the authorization information with resource owner consent received from the API invoker and requests the CCF entity 106 to provide the authorization information to invoke the service API provided in the second AEF entity 110.

In operation 708, the first AEF entity 108 may receive the authorization response message comprising authorization information from the CCF entity 106 based on the request authorization message. In operation 710, the first AEF entity 108 may send the at least one service API invocation request with the authorization information received from the CCF, to the second AEF entity 110. In operation 712, the first AEF entity 108 may receive the at least one service API invocation response from the second AEF entity 110 based on the at least one service API invocation request.

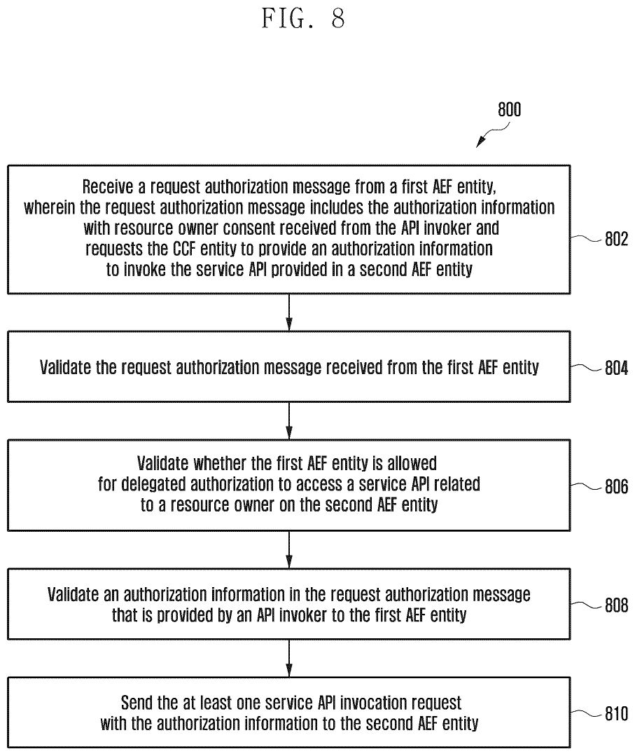

FIG. 8 is an example flow diagram 800 depicting a method for managing user consent for at least one nested API invocation in the wireless network 100, by the CCF entity 106 according to an embodiment of the disclosure.

Referring to FIG. 8, in operation 802, the CCF entity 106 may receive the request authorization message from the first AEF entity 108, where the request authorization message includes the authorization information with resource owner consent received from the API invoker and requests the CCF entity 106 to provide an authorization information to invoke the service API provided in the second AEF entity 110. In operation 804, the CCF entity 106 may validate the request authorization message received from the first AEF entity 108. In operation 806, the CCF entity 106 may validate whether the first AEF entity 108 is allowed for delegated authorization to access a service API related to a resource owner 104 on the second AEF entity 110.

In operation 808, the CCF entity 106 may validate an authorization information in the request authorization message that is provided by an API invoker 102 to the first AEF entity 108. In operation 810, the CCF entity 106 may send the authorization response message comprising authorization information to the first AEF entity 108 based on the validation.

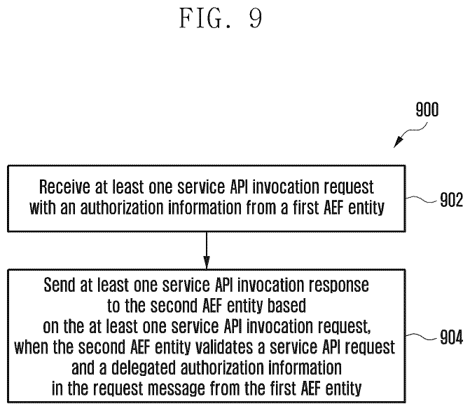

FIG. 9 is an example flow diagram 900 depicting a method for managing user consent for at least one nested API invocation in the wireless network 100, by the second AEF entity 110 according to an embodiment of the disclosure.

Referring to FIG. 9, in operation 902, the second AEF entity 110 may receive at least one service API invocation request with an authorization information from a first AEF entity 108. In operation 904, the second AEF entity 110 may send at least one service API invocation response to the second AEF entity 110 based on the at least one service API invocation request, when the second AEF entity 110 validates a service API request and a delegated authorization information in the request message from the first AEF entity 108.

The various actions, acts, blocks, steps, or the like in the flow charts/diagrams 700, 800, 900 may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the network elements. The elements include blocks which can be at least one of a hardware device, or a combination of hardware device and software module.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an application-specific integrated circuit (ASIC), or a combination of hardware and software means, e.g., an ASIC and a field programmable gate array (FPGA), or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first application programming interface (API) exposing function (AEF) in a wireless communication system, the method comprising:
identifying authorization information based on a first service API invocation request;
sending, to a common API framework core function (CCF), a request message to get new authorization information, the request message including the authorization information;
receiving, from the CCF, a response message including the new authorization information generated by the CCF in case that the first AEF is allowed for accessing a requested service API for a second AEF; and
sending, to the second AEF, a second service API invocation request including the new authorization information.

2. The method of claim 1, wherein the new authorization information is associated with whether the first AEF is authorized to invoke the requested service API.

3. The method of claim 1, wherein the request message includes information for security associated with the first AEF.

4. The method of claim 1, wherein the request message includes grant type information set as a token exchange.

5. The method of claim 1, wherein the response message includes at least one of:
information related to the first AEF,
information related to an API invoker,
information related to permitted services,
a resource owner identifier (ID), or
expiration time information.

6. A method performed by a common application programming interface (API) framework core function (CCF) in a wireless communication system, the method comprising:
receiving, from a first API exposing function (AEF), a request message to get new authorization information, the request message including authorization information identified based on a first service API invocation request;
validating that the first AEF is allowed for accessing a requested service API for a second AEF;
generating the new authorization information; and
sending, to the first AEF, a response message including the new authorization information.

7. The method of claim 6, wherein the new authorization information is associated with whether the first AEF is authorized to invoke the requested service API.

8. The method of claim 6, wherein the request message includes information for security associated with the first AEF.

9. The method of claim 6, wherein the request message includes grant type information set as a token exchange.

10. The method of claim 6, wherein the response message includes at least one of:
information related to the first AEF,
information related to an API invoker,
information related to permitted services,
a resource owner identifier (ID), or
expiration time information.

11. A first application programming interface (API) exposing function (AEF) in a wireless communication system, the first AEF comprising:
at least one transceiver;
at least one processor communicatively coupled to the at least one transceiver; and
at least one memory, communicatively coupled to the at least one processor, storing instructions executable by the at least one processor individually or in any combination to cause the first AEF to:
identify authorization information based on a first service API invocation request,
send, to a common API framework core function (CCF), a request message to get new authorization information, the request message including the authorization information,
receive, from the CCF, a response message including the new authorization information generated by the CCF in case that the first AEF is allowed for accessing a requested service API for a second AEF, and
send, to the second AEF, a second service API invocation request including the new authorization information.

12. The first AEF of claim 11, wherein the new authorization information is associated with whether the first AEF is authorized to invoke the requested service API.

13. The first AEF of claim 11, wherein the request message includes information for security associated with the first AEF.

14. The first AEF of claim 11, wherein the request message includes grant type information set as a token exchange.

15. The first AEF of claim 11, wherein the response message includes at least one of:
information related to the first AEF,
information related to an API invoker,
information related to permitted services,
a resource owner identifier (ID), or
expiration time information.

16. A common application programming interface (API) framework core function (CCF) in a wireless communication system, the CCF comprising:
at least one transceiver;
at least one processor communicatively coupled to the at least one transceiver; and
at least one memory, communicatively coupled to the at least one processor, storing instructions executable by the at least one processor individually or in any combination to cause the CCF to:
receive, from a first API exposing function (AEF), a request message to get new authorization information, the request message including authorization information identified based on a first service API invocation request,
validate that the first AEF is allowed for accessing a requested service API for a second AEF,
generate the new authorization information, and
send, to the first AEF, a response message including the new authorization information.

17. The CCF of claim 16, wherein the new authorization information is associated with whether the first AEF is authorized to invoke the requested service API.

18. The CCF of claim 16, wherein the request message includes information for security associated with the first AEF.

19. The CCF of claim 16, wherein the request message includes grant type information set as a token exchange.

20. The CCF of claim 16, wherein the response message includes at least one of:
information related to the first AEF,
information related to an API invoker,
information related to permitted services,
a resource owner identifier (ID), or
expiration time information.
